(19) United States
(12) Patent Application Publication
(10) Pub. No.: US 2006/0218778 A1
(43) Pub. Date: Oct. 5, 2006

(54) Flexible conducting thread

(76) Inventors: Govindaraj Jawahar, Virudhunagar (IN); Sundarraj Senthilkumar, Coimbatore (IN); Thangavel Balakrishnan, Madurai (IN); Valamalai Sudhakar Balan, Madurai (IN)

Correspondence Address: MCCORMICK, PAULDING & HUBER LLP, CITY PLACE II, 185 ASYLUM STREET, HARTFORD, CT, 06103, US

(21) Appl. No.: 11/257,720

(22) Filed: Oct. 25, 2005

(30) Foreign Application Priority Data
Apr. 4, 2005 (IN) 370/CHE/2005

(51) Int. Cl. H01B 11/00

(52) U.S. Cl. 29/605; 174/24; 29/825

(57) ABSTRACT

The invention provides a method of producing a flexible conducting thread for signal transmission and electrical conductivity. Flexible conducting thread is made up of one or more flexible conductors. The flexible conductors are developed by wrapping a conductive filament over non-conductive core filament and then electroplated uniformly on the surface of the conductive sheath. Thus produced flexible conductor is insulated using a non-conductive filament, resulting a product having electrical and textiles properties. This flexible conductor with or without insulation can be used in Smart textiles, medical garments and industrial applications.

### CROSS REFERENCE TO RELATED APPLICATIONS

This application claims priority to foreign Indian patent application 370/CHE/2005 filed on Apr. 4, 2005 and titled “Flexible Conducting Thread”. The disclosure of the above-identified application is incorporated in its entirety herein by reference.

### FIELD OF THE INVENTION

The present invention relates to a method of producing flexible conducting thread with a predetermined electrical and textile properties. In particular, a conducting thread, which is more flexible, uniform in thickness, good sew-ability and lightweight in nature.

### BACKGROUND OF THE INVENTION

Conducting wires are capable of transmitting electrical signal and data across. Conducting wires made out of materials like copper and insulated using non-conductive polymers material. However, these insulated wires are solid or rigid thus it does not provide much flexibility.

Medical field is in search of finding a suitable material that can be used in fabrics for sensing the human body vital signs. The existing conducting wire does not support the need very well due to its non-flexible characteristics, thus it is extremely difficult to use the existing one for wearable electronics medical science.

Mixing of broken stainless steel fibers with natural or synthetic textile fibers to produce conductive yarn is well known. The conductive materials are dispersed through the cross section of the yarn during spinning. However, since the modulus of elasticity of metal and textile fiber differ significantly, it is difficult to reach and retain a permanently homogeneous metal distribution in the yarn. In particular, when repeatedly loading the yarns under tensile or bending or torsion stresses, the initial fiber distribution may alter in the yarn cross-section as well as along the yarn length. Consequently its conductivity may change in an uncontrollable manner and it is not very much flexible.

Electrically conductive yarn for an electrical safety circuit or fuse is described in U.S. Pat. No. 5,927,060 of Mr. Watson. It describes that a composite longitudinally balanced electrically conductive yarn has a textile fiber core yarn wrapped with a minimum of two, and a maximum four filaments. One to four of the filaments are metal filaments with the remainder being synthetic filaments. Each metal filament has an equivalent diameter of between 20 and 80 microns, and a wrap frequency of between 200 and 600 turns per meter. At least one of the metal filaments is wrapped in one direction, and at least one of the remaining filaments is wrapped in the opposite direction. The composite yarns of this invention is capable of elongation to accommodate tensile stresses under use, without experiencing a change in conductivity.

Problems with electrically conductive yarn described in the aforesaid United States patent are that it is only capable of elongation to accommodate tensile stresses under use, without experiencing a change in conductivity, but cannot promise the much needed textile and electrical properties for industrial and commercial usage as it does not follow any specific process to take care of uniformity of the surface of the conductive sheath. Flexibility of yarn inversely proportional to its denier and the said patent uses non-conductive core filament of minimum 250 denier, which is considerably high. In the present invention, uniformity is achieved by following a gapless wrapping and electroplating process. The proposed process permits selection of low denier non-conductive core filament and conductive filament. Thus, the present invention produces conducting thread, which is thinner and more flexible.

Conductive yarn for fencing jacket is described in U.S. Pat. No. 5,881,547 of Chiou. The aforesaid U.S. patent describes that conductive yarn made in this way has better softness, high impact strength, and good conducting properties, and is especially adaptable for use in fencing jackets. Since the patent was aimed at producing fencing jacket, it did not give solutions to manufacture a conducting yarn, which has both textile and electrical properties.

Based on the foregoing, general object of the present invention is to provide a conducting thread and a method of manufacturing a conducting thread that improves upon, or overcomes the problems and drawbacks associated with the prior arts. Accordingly it is an object of the present invention to produce a conducting thread to serve the much-needed flexibility. Another object of the present invention is to provide sewability without compromising the electrical properties, so that it can be very well used in industrial and commercial applications.

Additional advantages and novel features of the invention will be set forth in part in the description which follows, and in part will become apparent to those skilled in the art upon examination of the following or may be learned by practice of the invention. The objectives and advantages of the invention may be realized and achieved by means of commercial usage.

### SUMMARY OF THE INVENTION

Over the years, the focus on textile materials has shifted from general to specific applications. It is no longer limited to primary functions of covering the human body. The diversification and technological advance of textile sciences has reached to such an extent that no area seems to be untouched by textiles.

Nowadays, role of fabrics should be able to sense the surrounding and internal factors of the human body responds to it and actuate. These kinds of fabrics are also called as “Smart textiles”. It belongs to textiles industries with additional functions, which conventional textiles do not have. The well known functions of non conducting textile filaments, conductive metal filaments and conductive materials are diversified to meet out the present challenge and expectations of electrical, computer, medical, textiles science and engineering fields thus importing special and specific functions of conducting current and signal transmissions through them by special construction and designing, which has emerged into a new Flexible Conducting Thread.

Manufacturing of Flexible Conducting Thread yields multi-faced results in textile and electrical fields. This flexible conducting thread can be suitably used in various specifications matching to the requisites of the modern scientific era of textile, electrical, electronics, information technology, medical and avionics etc.,

The existing challenge for the necessity of producing a conducting thread in the place of existing filament wires can be eradicated by the entry of these conducting thread, which has both the characters of filament wires and that of textile threads. The flexible conducting thread is cost effective, perfect substitute for filament wires, has better performance of flexibility.

It is an object of the invention to design a flexible conducting thread comprising non-conductive core filament, conductive metal filament to form a conductive sheath and electroplated before covering it using non-conductive material to have a predetermined electrical conductivity, which remains unchanged during usage. Depending upon the conducting thread's requirement, the non-conductive filament and conductive filament deniers, electroplating in percentage, and non-conductive insulation filament denier and also coils per inch of insulation filament are decided. Above-mentioned deniers, electroplating material percentage and coils per inch are variable factors, which decide the textiles and electrical properties of the conducting thread.

The non-conductive core filament preferably polyester has a size between 10 to 3000 deniers and preferably between 20 to 2600 deniers and conductive filaments preferably copper has a size between 10 to 2600 deniers and preferably between 20 to 2200 deniers used for producing the conductive sheath. Conductive filament wrapped over the non-conductive core filament measured in coils per inch and it depends on the denier of the conductive filament used. Flexible conductors assembly produced by twisting the predetermined number of flexible conductors and the twist ranges from 0 to 70 twists per inch. However the preferred electrical properties decided up on electroplating metal and number of flexible conductors used in flexible conductor assembly. Electroplating metal preferably silver with percentage of 1.8 used for producing the flexible conductor, however preferable range is above 0.5%. Non-conductive filament used for insulation is preferably polyester or nylon with range of above 100 deniers.

For example, selecting four flexible conductors can produce a finer flexible conducting thread. Selected conductors are compiled in parallel winding process before proceeding for twisting and insulation process. This Finer flexible conducting thread made out of four flexible conductors was tested in ambient temperature on a experimental basis and measured current carrying capacity was 1.75 Amps and Resistance of 9.75 Ω/m. Temperature co-efficient measured is positive, thickness of the single flexible conductor is 0.1 mm, thickness of flexible conducting thread without insulation is 0.15 mm and with insulation is 0.3 mm. Further, a finer flexible conducting thread was sewn in to a reinforced synthetic cloth in 7 Stitches Per Inch for the purpose of identifying sew-ability. The seam strength, maximum seam opening, maximum force of un sewn in warp way direction measured 140 Newton, 17 mm, 226 Newton respectively and the seam strength, maximum seam opening, maximum force of un sewn in weft way direction was found 169 Newton, 8 mm, 279 Newton respectively. Thus finer flexible conducting thread test results showed better sew-ability.

For example, selecting sixteen flexible conductors can produce a coarser flexible conducting thread. Selected conductors are compiled in parallel winding process before proceeding for twisting and insulation process. Nylon is used as non-conductive filament for insulation. This coarser flexible conducting thread made out of sixteen flexible conductors was tested in ambient temperature on a experimental basis and measured current carrying capacity was 4.60 Amps and Resistance of 1.95 Ω/m. Temperature co-efficient measured for is positive, thickness of the single flexible conductor is 0.1 mm, thickness of flexible conducting thread without insulation is 0.5 mm and with insulation is 0.9 mm. Further a Coarser flexible conducting thread which is mentioned in the above example was sewn in to a reinforced synthetic cloth in 7 Stitches Per Inch for the purpose of identifying sew-ability. The seam strength, maximum seam opening, maximum force of un sewn in warp way direction was found 170 Newton, 20 mm, 236 Newton respectively and the seam strength, maximum seam opening, maximum force of un sewn in weft way direction measured 207 Newton, 10 mm, 286 Newton respectively. Thus coarser flexible conducting thread test results showed better sew-ability.

Any number of flexible conductors can be taken for making a final conducting thread as it's purely based on the type of thread to be made. Thus four or sixteen conductors used in foresaid examples do not have any significance. Flexible conducting thread can be produced with or without insulations based on the application requirements. Flexible conductors can be directly used as conducting thread without insulation if an application demands non-insulation characteristics as the flexible conductors without insulation also flexible as the way it's manufactured.

Flexible conductor comprises; non-conductive core filament denier, copper conductive filament denier, and electroplating metal and percentage used for above examples are 36 denier, 44 denier, silver and the percentage is 1.8 respectively. Thus desired current carrying capacity can be achieved by selecting the different deniers of non-conductive and conductive filaments and by selecting electroplating metal and percentage of electroplating.

According to an additional object of the invention, the flexible conducting thread is balanced and uniform along its length by electroplating on its surface. In summary, the Flexible Conducting Thread is a conducting thread with or without insulation, which has one or more flexible conductor(s). Non-conductive core filament and insulating layer includes material selected from group consisting of polyester, yarn, thread, and glass yarn.

It is an invention for signal transmission and current conduction, obtained by covering of conductive metal filament wrapping on the surface of fine non conductive textile filament material and electroplated by conductive metal resulting as a flexible conductor. Again selected number of conductors insulated by non-conductive textile filament, resulting as a product having characteristics of conducting wire and textile thread. It is simple to import desired multi functional characteristics such as good conductive performance, fire proof, waterproof, antistatic finish, anti bacterial finish etc by adopting suitable non-conductive, conductive filament selection and suitable selection of good conductive electroplating process to the Flexible Conducting Thread. Flexible conducting thread has good flexibility characteristics to produce any woven and knitted fabric.

### BRIEF DESCRIPTION OF THE DRAWINGS

FIG. 1 is a sequence diagram to depict various process steps involved to manufacture the flexible conducting thread.

FIG. 2 shows longitudinal view of single conductor.

FIG. 3 shows cross sectional view of single flexible conductor at section X-X in FIG. 2.

FIG. 4 shows cross sectional view of flexible conducting thread with a single flexible conductor insulated.

FIG. 5 shows longitudinal view of flexible conducting thread with four flexible conductors insulated.

FIG. 6 is a schematic view of process involved in wrapping a conductive filament over non-conductive core filament as indicated in FIG. 1, box number 3.

FIG. 7 is a schematic view of parallel winding process as indicated in FIG. 1, box number 6.

FIG. 8 is a schematic view of Two for One twisting process as indicated in FIG. 1, box number 7.

FIG. 9 is a schematic view of the insulation process (Wrapping process) as indicated in FIG. 1, box number 8.

FIG. 10 is an example of Flexible conducting threads used in fabric.

### DETAILED DESCRIPTION OF THE PREFERRED EMBODIMENTS

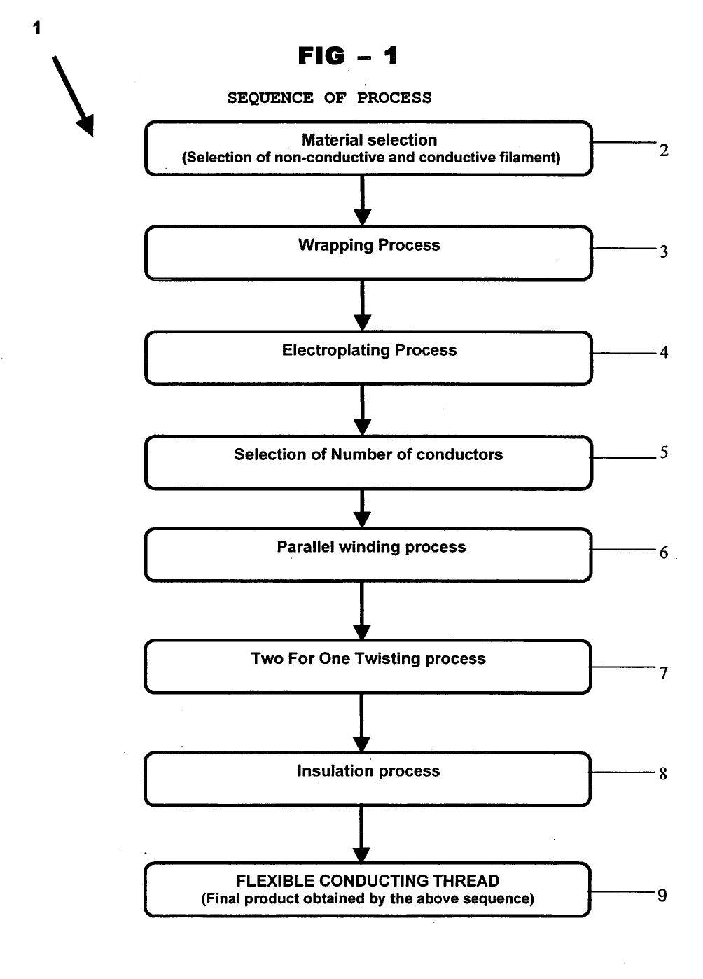

With reference to the drawings and particularly FIG. 1 describes the sequence of process steps 1 to be followed for manufacturing flexible conducting thread. The sequence of process describes material selection 2 of identifying non-conductive core filament and conductive filament, wrapping process 3 to wrap the conductive filament over non-conductive core filament, electroplating process 4 to coat conductive metal on the surface of the conductive sheath, selection of number of conductors 5 to determine number of conductors to be used for flexible conductor assembly, parallel winding process 6 and Two for One twisting process 7 to increase the strength of the flexible conducting thread, insulation process 8 to protect conductive layer and produce flexible conducting thread 9 as per predefined requirements.

The method of manufacturing a flexible conducting thread starts from material selection of non-conductive core filament 20 and conductive filament 30. Polyester and Copper are used as non-conductive core filament and conductive filament respectively. The non-conductive polyester has good strength and better flexibility in nature and the conductive filament copper has good electrical conductivity. The conductive filament copper alone will not disperse the impact of loads and heavy bending stress during mechanical actions and will not withstand the needle actions when its used for stitching into heavy fabrics and the filament will break which in turn spoils the electrical continuity. These problems are subdued by merging the non-conductive filament as core and conductive filament as sheath. This conductive sheath on non-conductive core filament provides required ability to withstand mechanical actions such as weaving, knitting and stitching and also the electrical continuity and conductivity will not be affected.

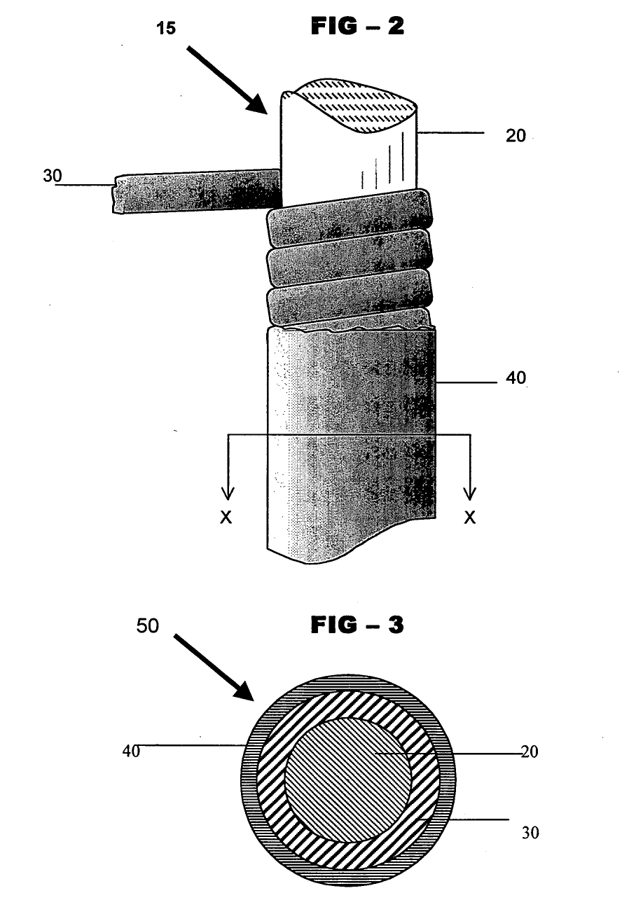

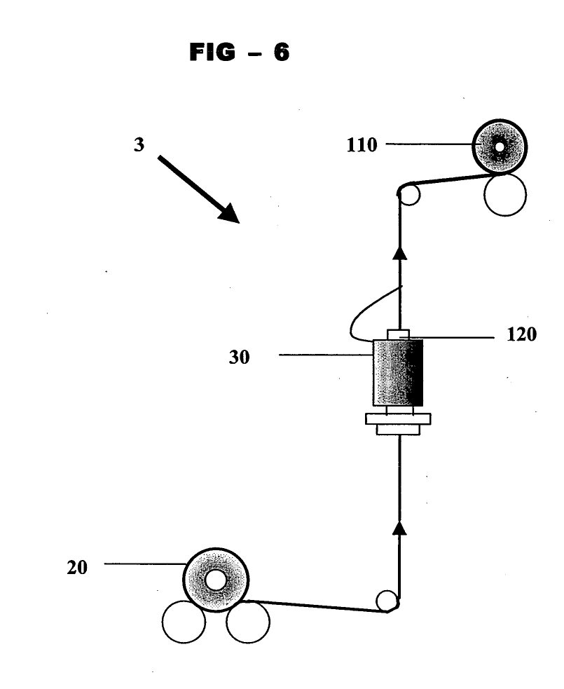

The above mentioned non-conductive polyester core filament and conductive copper filament are integrated by a process called wrapping. In this wrapping process 3 as shown in FIG. 6, the non-conductive polyester filament used and conductive copper filaments have been used to form conductive sheath about the core filament as shown in FIG. 2. The non-conductive polyester core passed through the hollow spindle 120 of the covering machine and the conductive filament copper wrapped completely without any gap on the surface of the nonconductive polyester core resulting in a conductive sheath 110. This integrated process output collected on a delivery package and transferred for electroplating process. Gapless wrapping helps the electroplating to be uniform on the surface of the conductive layer.

Electroplating is a process of depositing a conductive layer 40 over the conductive sheath uniformly, which provides uniformity and high-level protection from rust formation. Better conductivity can be always achieved by selecting high performance conductive material for electroplating. Generally the high performance conductive material has less resistance and higher conductivity performance. Silver is used as an electroplating metal for improving the conductivity over the conductive sheath, which forms a uniform conductive layer. The conductive layer formed on the conductive sheath substantially the entire length of the sheath thereby forming a conductor. FIG. 2 shows longitudinal view 15 and FIG. 3 shows cross sectional view 50 of a flexible conductor.

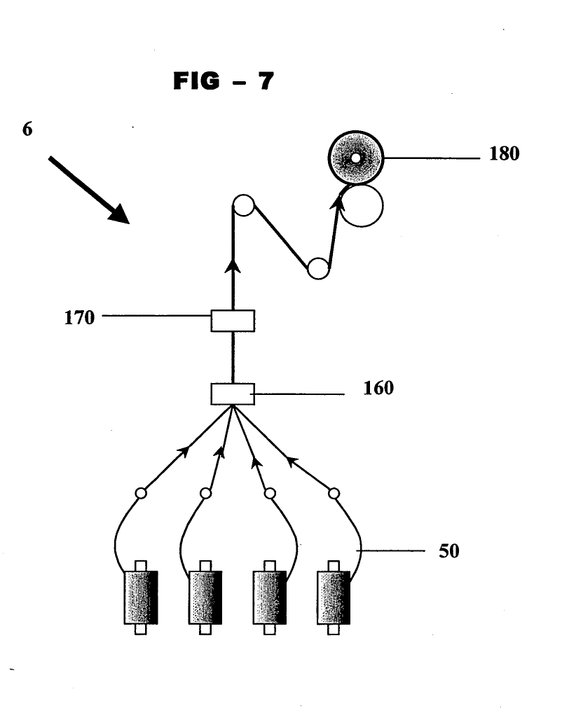

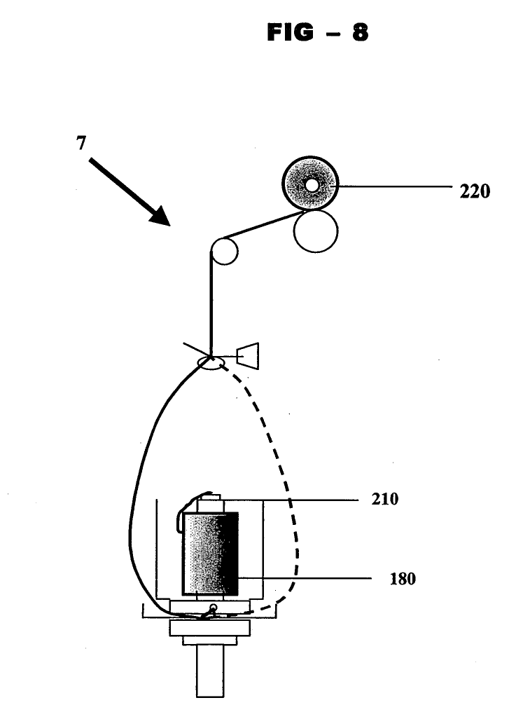

The behaviors such as conductivity, flexibility, thickness, and sew ability of the flexible conducting thread are based on the selection of numbers of flexible conductors. The selection of number of conductors in the flexible conducting thread is inversely proportional to the flexibility and sewability and directly proportional to the conductivity, thickness and weight per unit length. Based on current carrying capacity or signal transmission requirement, the selected flexible conductors kept in ready for parallel winding process 6. In this process, the selected number of conductors (In the FIG. 7, four such conductors are shown) are fed in to a guide slit 160 where they get arranged in parallel and further fed in to a tensioner 170 as shown in FIG. 7. Here, the conductors are compiled in parallel thus resulting as a flexible conductor assembly 180. Then the compiled flexible conductor assembly collected on a delivery package with out changing the parallel order and transferred to a twisting process. The flexible conductor assembly is packed substantially for the entire length of the conductor assembly by using Two For One (TFO) twister in twisting process 7. Here, the compiled flexible conductor assembly is fed in to the spindle 210 of the Two For One twister for getting the predetermined twist per Inch as shown in FIG. 8. The twisted flexible conductor assembly 220 collected on a delivery package and kept in for insulation process. Parallel winding process and TFO twisting process ensures the strength and conductivity of the flexible conducting thread.

The process of insulation of a flexible conducting thread starts with selecting a non-conductive filament material 80. Non-conductive material such as polyester or nylon is used for insulation process and selection of particular material is based on the textile property requirement and number of flexible conductors used for manufacturing the flexible conducting thread. Insulation is a process to protect the conductors from reacting to the atmospheric influence and to make a barrier to reduce the external forces during usage. The protection capability of insulation is mainly depends on type of non-conductive filament, layers of insulation, and wrapping coils per inch.

The main advantage of the non-conductive filament wrapping is that it gives better flexibility to the final conducting thread because of its nature of wrapping such that there is no real bond between the subsequent coils wrapping using non-conductive filament. In the general approach, the polymer molding insulation results in strong bond to their entire length of the conductor, which will resist the flexibility.

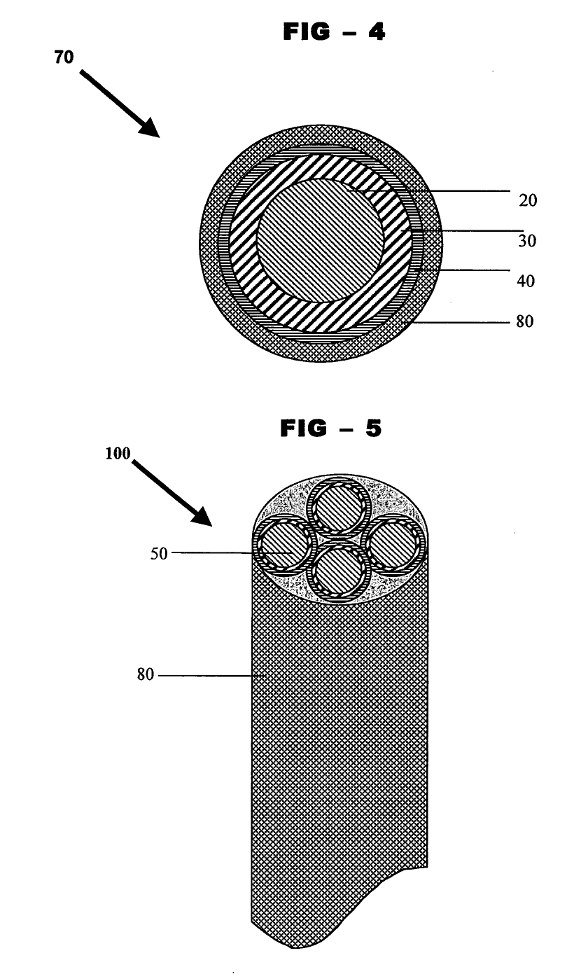

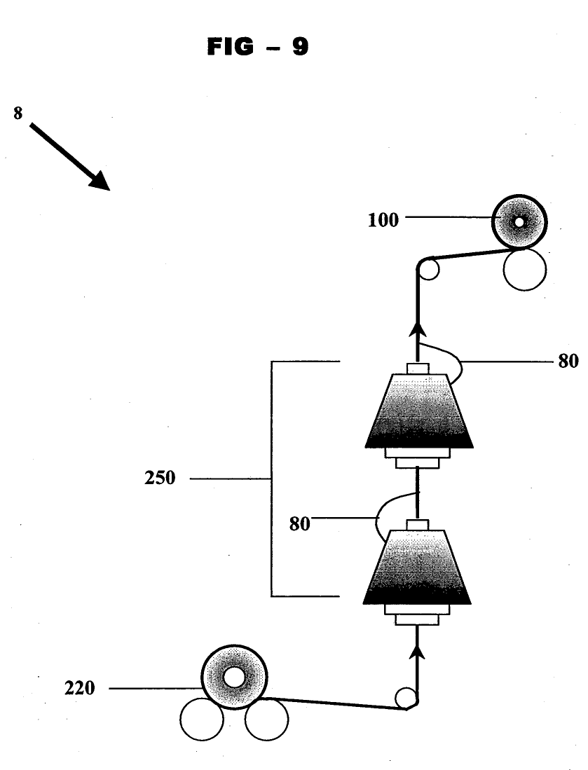

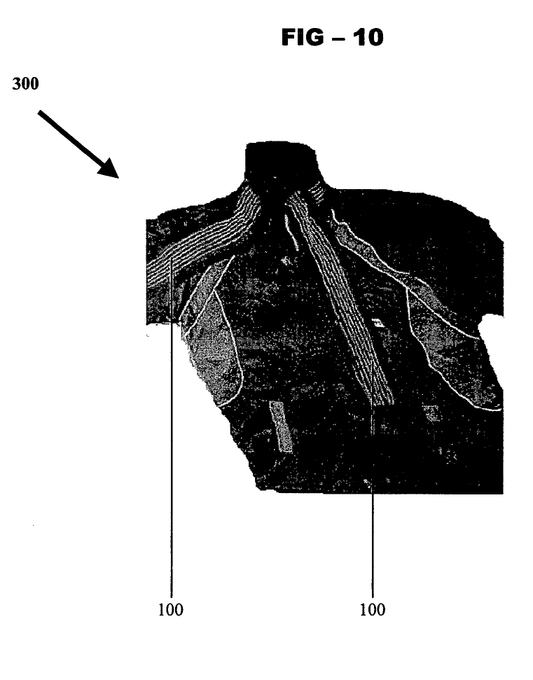

In this insulation process 8, the selected non-conductive filament insulates the twisted flexible conductor assembly by the “X-wrap” method 250 as shown in FIG. 9. Here, wrapping a non-conductive polyester filament around the single conductor or twisted conductors in a first direction forming first insulating layer and wrapping a non-conductive polyester filament in a second direction around the first insulating layer forming a second insulating layer, the second direction being opposite to the first direction. FIG. 4 shows cross sectional view 70 and FIG. 5 shows longitudinal view 100 of flexible conducting thread. FIG. 10 shows how the Flexible conducting threads are sewed in jacket fabric 300.

Some of the advantages of Flexible conducting thread are:

It can be used in wearable electronics to sense human body vital signs. One or more flexible conducting thread with insulation can be used in non-conductive conventional fabrics for signal transmission and current conduction.

It can be used in entertainment applications to give virtual effect. For example, by manufacturing a curtain using flexible conducting thread can be used in home theater to create virtual effect by means of adding glowing material on the surface of the insulation.

Flexible Conducting thread without insulation can be used in industrial application to produce curtains for protecting human working on machineries.

The foregoing description of embodiments of the invention has been presented for the purpose of illustration and description, it is not intended to be exhaustive or to limit the invention to the form disclosed. Obvious modifications and variations are possible in light of the above disclosure. The embodiments described were chosen to best illustrate the principals of the invention and practical applications thereof to enable one of ordinary skill in the art to utilize the invention in various embodiments and with various modifications as suited to the particular use contemplated. It is intended that the scope of the invention be defined by the claims appended here to.

1. A method for making a flexible conductor, comprising:
providing a non-conductive core filament;
wrapping a conductive filament a plurality of gapless rotations around the non-conductive core filament, the conductive filament forming a conductive sheath about the core filament;
electroplating a conductive layer on the conductive sheath substantially the entire length of the sheath thereby forming a flexible conductor.

2. The method of claim 1 further comprising a step of compiling a plurality of said flexible conductors arranged in parallel forming a flexible conductor assembly.

3. The method of claim 2 further comprising a step of twisting a plurality of said flexible conductors together for increasing the strength and conductivity of said flexible conductor.

4. The method of claim 1 further comprising a step of wrapping a non-conductive filament over the conductive layer forming an insulating layer on an outer surface of the flexible conductor.

5. The method of claim 3 further comprising a step of wrapping a non-conductive filament over the plurality of flexible conductors forming an insulating layer on an outer surface thereof.

6. The method of claim 4 wherein the step of wrapping a non-conductive filament further includes wrapping a non-conductive filament around the conductive layer in a first direction forming a first insulating layer and wrapping a non-conductive filament in a second direction around the first insulating layer forming a second insulating layer, the second direction being generally opposite the first direction.

7. The method of claim 4 further comprising a step of assembling a plurality of said flexible conductors together thereby forming a fabric.

8. The method of claim 7 wherein the step of assembling includes weaving a plurality of said flexible conductors together.

9. The method of claim 4 further comprising coating the insulating layer by applying at least one of a fireproofing, waterproofing, inking, anti-static, and anti-bacterial material or treatment to the insulating layer.

10. The method of claim 1 wherein the step of providing a non-conductive core filament includes providing a filament including polyester.

11. The method of claim 1 wherein the step of wrapping a conductive filament a plurality of gapless rotations around the non-conductive core filament, includes wrapping a copper or an alloy filament around the non-conductive core filament.

12. The method of claim 1 wherein the step of electroplating a conductive layer on the conductive sheath includes electroplating a layer of silver or other metal on the conductive sheath.

13. The method of claim 4 wherein the step of wrapping a non-conductive filament over the conductive layer includes wrapping a non-conductive filament comprising polyester over the conductive layer.

14. A flexible conductor, comprising:
a non-conductive core filament;
a conductive filament wrapped around the core filament forming a conductive sheath on the core filament; and
a conductive layer electroplated around the conductive filament.

15. A flexible conductor according to claim 14, wherein the conductive filament is selected from the group consisting of copper and a copper alloy.

16. A flexible conductor according to claim 14, wherein the non-conductive core filament includes a material selected from the group consisting of polyester, yarn, thread, and glass yarn.

17. A flexible conductor according to claim 14 further comprising an insulating layer coupled to an outer surface of the conductive layer.

18. A flexible conductor according to claim 17 wherein the insulating layer includes a material selected the group consisting of polyester, yarn, thread, glass yarn and nylon.

19. A conductive fabric comprising:
a plurality of flexible conductors assembled together; each said flexible conductor including a non-conductive core filament, a conductive filament wrapped around the core filament forming a conductive sheath on the core filament, a conductive layer electroplated around the conductive filament, and an insulating layer coupled to the conductive layer forming an outer surface of the flexible conductor.

20. The conductive fabric according to claim 19 wherein the plurality of flexible conductors are weaved or knitted together.

21. A conductive fabric comprising:
a conventional non-conductive fabric;
at least one flexible conductor coupled to the conventional fabric, the flexible conductor including a non-conductive core filament, a conductive filament wrapped around the core filament forming a conductive sheath on the core filament, a conductive layer electroplated around the conductive filament, and an insulating layer coupled to the conductive layer forming an outer surface of the flexible conductor.
